(19) United States
(12) Patent Application Publication
(10) Pub. No.: US 2014/0142964 A1
(43) Pub. Date: May 22, 2014

(54) Providing Price Transparency and Contracted Rates to Dental Care Customers

(71) Applicant: Aetna Inc., Hartford, CT (US)

(72) Inventors: Lauren LANG, Hartford, CT (US); Wayne GOWDY, Tolland, CT (US); Karen RUTKOWSKI, Glastonbury, CT (US); Daniel FISHBEIN, Hartford, CT (US); Marcia VANNUCCINI, Hartford, CT (US)

(73) Assignee: Aetna Inc., Hartford, CT (US)

(21) Appl. No.: 14/052,128

(22) Filed: Oct. 11, 2013

Related U.S. Application Data
(63) Continuation-in-part of application No. 13/964,780, filed on Aug. 12, 2013.
Application No. 13/964,780 is a continuation-in-part of application No. 11/334,865, filed on Jan. 19, 2006.
(60) Provisional application No. 61/713,070, filed on Oct. 12, 2012.

(51) Int. Cl. G06F 19/00

(52) U.S. Cl. CPC G06F 19/328
USPC 705/2

(57) ABSTRACT

Systems and methods are described for providing consumers with access to the discounted rates for health care procedures provided by dentists, primary care physicians, specialist physicians and facilities. Fee information for contracted providers is stored in a database and is accessible to consumers via an online interface. Dentists or health care providers can receive payment from a customer's pre-funded account in exchange for health/dental services provided to a customer, through the use of a health/dental care card. The card is issued to the customer by a health plan organization and is linked to a pre-funded account for that customer. The health care provider is under contract with the organization to offer a predetermined fee structure for covered services. Customers can obtain contracted rates for services via the card, regardless of any limitations that might apply under a health insurance policy or other program

This application is a continuation-in-part of prior application Ser. No. 11/334,865, filed Jan. 19, 2006. This application is also a continuation-in-part of prior application Ser. No. 13/964,780, filed Aug. 12, 2013, which is a continuation of prior application Ser. No. 11/457,449, filed Jul. 13, 2006, now issued as U.S. Pat. No. 8,510,124. This application also claims the benefit of U.S. Provisional Application No. 61/713,070, filed Oct. 12, 2012.

### FIELD OF THE INVENTION

This invention relates generally to the field of health insurance and more specifically to the area of price and information transparency for contracted health/dental care providers.

### BACKGROUND OF THE INVENTION

Imagine a world without price tags. A consumer can buy a big screen TV that he's had his eye on, but he would not know the price until his credit card bill came in the mail. Although this seems like a ridiculous proposition, it is exactly the world the average American lives in when he or she seeks medical care. As reported in the Wall Street Journal in February and June of 2005, knowing the cost of a doctor's visit has long been a missing piece of the health care decision-making process.

One previously unachievable approach is called “price transparency.” Through price transparency, consumers would be able to know what they can expect to pay at the physician's office before visiting the physician. However, in previous health care systems, no health insurer has ever been able to provide this level of detail to its members. The reasons for this have been varied—contractual issues, complexities in the rates physicians agree to accept from insurers, and concerns about consumers shopping for health care on price alone. Similar concerns have been raised in the dental care context.

Furthermore, an individual without health or dental insurance coverage has traditionally been unable to receive the benefit of any contracted rate his health care providers may have negotiated with an insurance company, and the overall cost for the services may therefore still be significantly higher than if he was insured and the services were covered. This discourages individuals from obtaining proper medical or dental care. For example, 50% of the U.S. population does not have dental insurance, even though most are offered the opportunity to enroll.

### BRIEF SUMMARY OF THE INVENTION

Embodiments of the invention provide consumers with online access to the negotiated discounted rates for health/dental care procedures provided by primary care and specialist physicians, and dental health workers. This provides advantages by educating consumers about the actual costs of medical/dental care, responding to a need of the employer and broker communities. Such embodiments are particularly valuable in the face of the increased adoption of consumer-directed health plans, which necessitate more detailed information than had previously been available for health issues, health care quality, and average pricing within specific geographies.

Using embodiments of the invention, consumers can research what they can expect to pay at a doctor's or dentist's office before going in for a visit. The research can be conducted securely via a password-protected interface to a query engine, such as a member website. The query engine can access information on health/dental providers and health/dental provider groups in conjunction with a health/dental insurance company or other health plan organization. Members can search for a physician or dentists and, upon selecting a physician or dentist, can view negotiated contracted rates. This provides advantages to members who are selecting health or dental care providers for services, and also to members who may be choosing health or dental care benefits at the beginning of a plan year. By raising awareness about the costs of care, the marketplace for consumers as health care decision-makers is enhanced.

Embodiments of the invention provide information on overall value, not just price alone. Quality and efficiency measures are used and are in alignment with the Institute of Medicine's criteria for efficiency and effectiveness.

Embodiments of the invention are further used for allowing a heath/dental care provider or merchant to receive payment from a customer's FSA, HRA, HSA or other type of pre-funded account in exchange for services or goods provided to a customer through the use of a healthcare/dental card. The card is issued to the customer by or in conjunction with a health plan organization, such as a health insurance company. The card is funded by the customer or his employer, and may be linked to an FSA/HRA/HSA account for that customer. The health plan organization need not be a health insurance company, however. The health/dental care provider is under contract with the health plan organization to offer a predetermined fee structure for covered services provided. By using the healthcare/dental card at the time of service, customers can obtain contracted rates regardless of any specific benefit limitations of their health/dental insurance plan, and regardless of any medical necessity determination that might otherwise be required for coverage under a health/dental insurance plan. Thus, unlike prior FSA/HRA/HSA payment systems, embodiments of the current invention allow any cardholder to obtain contracted rates for services, regardless of whether or not the cardholder is even a member of a health/dental insurance plan

A further advantage of the present invention is that health/dental care service providers can be guaranteed immediate payment of funds for services rendered to patients who use a fund-based healthcare/dental card. The card is linked to an FSA/HRA/HSA or other pre-funded account for the patient. At the time services are provided, the provider can use the card to complete all aspects of the transaction, without any need for later processing or claim settlement. The card can be used to substantiate the service charges against applicable governmental rules.

A further advantage is that a consumer can use an online portal to review multiple procedures while comparing the retail versus negotiated rates in his area, and can load an appropriate amount of funds onto a prepaid debit card.

Another advantage of the present invention is that substantiation of payment claims to ensure they are not outside the guidelines for FSA/HRA/HSA coverage can be accomplished online, in real time, and even prior to the provision of services. Prior FSA/HRA/HSA reimbursement or payment systems necessitated intensive manual processes and forms to accomplish this task.

Still another advantage found in embodiments of the present invention is health care providers can choose whether to be paid through a conventional credit/debit card network transaction, or directly from the health plan organization administering the FSA/HRA/HSA or other type of pre-funded account via an electronic funds transfer into the provider's bank account. Prior FSA/HRA/HSA reimbursement systems required the provider to use either a credit/debit card network or manually submit forms.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1A is a diagram of a system used to provide health/dental care provider information to consumers, in accordance with an embodiment of the invention;

FIG. 1B is a general overview of networks and components used for processing FSA/HRA/HSA or other pre-funded account transactions with a health/dental care card, as contemplated by an embodiment of the present invention;

FIGS. 2-8 are screenshots illustrating exemplary user interfaces for presenting health/dental care provider information, in accordance with an embodiment of the invention;

FIG. 9 is an exemplary presentation of price information for a health/dental care provider, in accordance with an embodiment of the invention;

FIG. 10 is an exemplary presentation of comparative data between health/dental care providers, in accordance with an embodiment of the invention;

FIG. 11 is an exemplary presentation of quality and efficiency information for a provider, in accordance with an embodiment of the invention;

FIG. 12 is a flow diagram of a technique for presenting health/dental care cost information to a consumer, in accordance with an embodiment of the invention;

FIG. 13 is a flowchart illustrating a method of using a FSA/HRA/HSA-linked health/dental care card at a health service provider to allow real-time payment to the provider at a contracted rate, in accordance with an embodiment of the invention;

FIG. 14 is a flowchart illustrating a method of using a FSA/HRA/HSA-linked health/dental care card at a health service provider to allow real-time substantiation of claims, in accordance with an embodiment of the invention;

FIG. 15 is a diagram illustrating a health/dental care card for linking with a FSA/HRA/HSA or pre-paid debit account, in accordance with an embodiment of the invention;

FIGS. 16-17 are screenshots illustrating an exemplary user interface for presenting a consumer dental card portal, in accordance with an embodiment of the invention; and

FIG. 18 is a flowchart illustrating a method of purchasing a stored value card or certificate for dental services, in accordance with an embodiment of the invention.

### DETAILED DESCRIPTION OF THE INVENTION

The following examples further illustrate the invention but, of course, should not be construed as in any way limiting its scope.

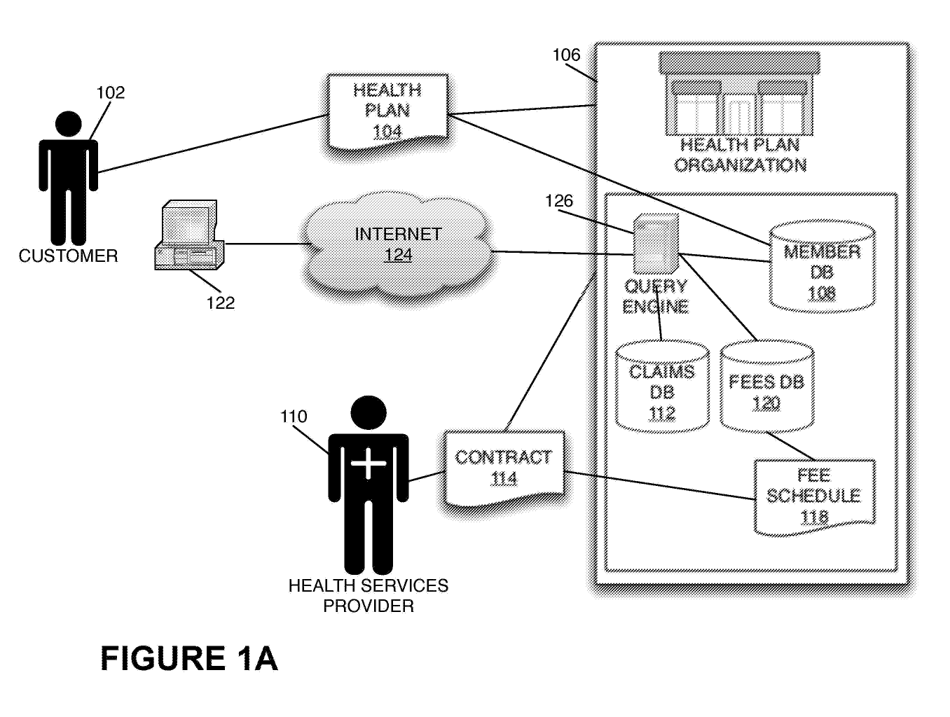

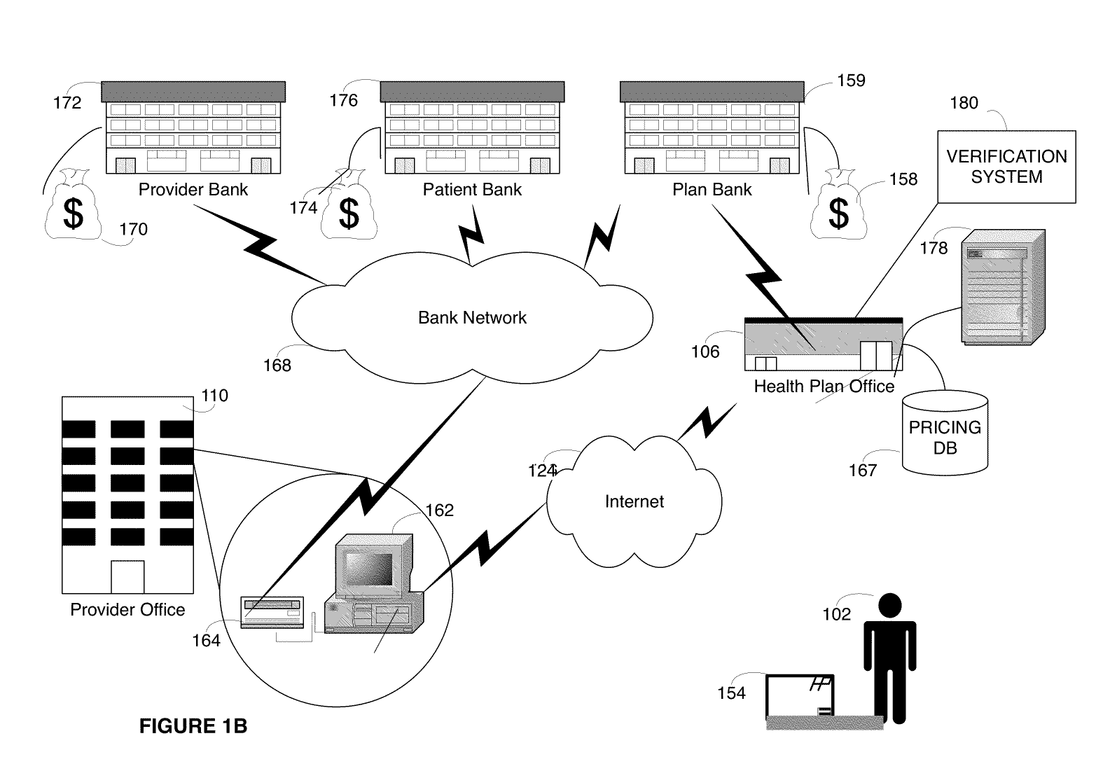

Turning to FIG. 1, an implementation of a system contemplated by an embodiment of the invention is shown with reference to an overall health/dental care environment. A consumer (“subscriber” or “member”) 102 is a member of a health/dental plan 104 of a health plan organization (“HPO”) 106. Alternatively, the consumer 102 is a prospective member of a health/dental plan 104, or is not a member of the plan 104. The consumer 102 may subscribe to the health/dental plan 104 through, for example, his employer. Alternatively, the consumer 102 may obtain benefits of the health/dental plan 104 through a subscriber (e.g., a spouse or child of a subscriber can be a member of a health/dental plan). The HPO 106 is typically a health insurance company and the health/dental plan 104 can be one of a number of health insurance or related products, such as a PPO, HMO, POS, or the like. The health/dental plan 104 can also be a consumer-directed health plan, such as a high deductible health plan, health reimbursement arrangement (HRA), health savings account (HSA) or the like. The plan 104 covers various health/dental care services according to one of a variety of pre-arranged terms, and details for the consumer 102 (if he is a member of the plan) and the corresponding plan 104 are preferably stored in a member database 108. The terms of the plan 104 can vary greatly from plan to plan according to: what types of services are provided, where the services are provided, by whom they are provided, the extent to which the patient is personally responsible for payment, amount of deductibles, etc. Generally, however, regardless of the specific plan subscribed to, when a consumer 102 obtains health care services from a provider 110, either the patient 102 or the provider 110 can submit a claim to the HPO 106 for reimbursement or payment. For analysis purposes, historical claim data is stored in a claims database 112.

A health/dental care services provider 110 may have a contractual relationship 114 with the HPO 106. Under the contract 114, the provider 110 typically agrees to provide services to members of the HPO 106 at scheduled rates. The rates are stored in a fee schedule 118, preferably stored in a fees database 120 maintained by the HPO 106. By contracting with the HPO 106, the provider 110 generally increases the amount of business he receives from members, and members generally receive a less expensive rate than they would otherwise receive for a health/dental service provided by the provider 110, and at least a portion of the provider's 110 compensation is generally paid by the HPO 106. The actual amount of out-of-pocket expense to be paid by a member may vary according to the terms of his health/dental plan 104 (e.g., co-payments, co-insurance or deductibles may apply), but will generally be at most the contracted rate. Historically, these contracted rates have been guarded fairly closely by HPOs 106. Consumers often would not become aware of their charges until after they were billed for past services. Moreover, different contracted providers may operate on different fee schedules for the same health/dental services without any knowledge by the consumer.

In an embodiment of the invention, consumers 102 can obtain cost information and other relevant data (quality information, efficiency information, etc.) prior to the provision of any health/dental services by a provider 110. The consumer 102 uses a computing device 122 to communicate via a network, such as the Internet 124, with the HPO 106. An interface is preferably provided so the consumer 102 can identify himself as a member of a health plan 104 of the HPO 106 or as a prospective customer for a health/dental care card, and so the consumer 102 can research information on providers 110 who prospectively may perform health services for the consumer 102. Through the interface, a query is sent to a query engine 126. The query engine 126 connects to one or more databases of the HPO and obtains price information, provider quality information, provider efficiency information, and/or other information that may be useful to the consumer's 102 deciding on a provider of health/dental services or on and amount of funds to load on a health/dental care card.

Turning to FIG. 1B, an implementation of a system contemplated by an embodiment of the invention is shown with reference to an overall health/dental care financial network environment. A patient 102 is issued a health/dental care card 154 by a health plan organization 106. Alternatively, the patient 102 is issued a certificate, which can be redeemed at a health/dental provider. In one embodiment, the health plan organization 106 is a health insurance company. Alternatively, the health plan organization administers health coverage programs for a self-insured employer. The patient may or may not be covered under any insurance plan of the health plan organization 106. The card 154 contains indicia relating to the patient's 102 identity and to an account 158 held by the health plan or the plan's bank 159. Additionally, the card 154 may contain information relating to a particular health/dental plan offered by the health plan organization 106. The account 158 is preferably associated with a health reimbursement arrangement (HRA) for the patient 102. Alternatively, the account 108 is associated with a flexible spending account (FSA) or a health savings account (HSA). Alternatively, the account 158 is associated with an account funded through employee post-tax payroll deductions. Alternatively, the account 158 is associated with an account funded directly by consumer contributions. Generally, health/dental care providers contract with health plan organizations to receive a specified payment for services provided to individuals enrolled in a plan associated with that organization. As the patient's portion of financial responsibility grows, for example, through the use of plans with higher deductibles, the assurance of payment correspondingly becomes of increasing importance to the provider. Because a patient 102 need not be covered by an insurance policy in order to hold an HRA or FSA, an uninsured patient using a health/dental care card 154 issued by the health plan organization 106 and linked to the patient's HRA or FSA or other type of pre-funded account 158, as used in some embodiments of the invention, may nevertheless receive health/dental care services at the generally lower contracted prices. In another embodiment, the card 104 may have a predetermined stored value associated with it, allowing it to be purchased by anyone at a retail point of sale, such as a drug store or convenience store. In that embodiment, after purchasing the card, the purchaser would be able to use the card to obtain health/dental care products or services at contract rates from participating providers, in an amount up to the value associated with the card. In other embodiments, the card is rechargeable or re-loadable. For example, the cardholder may add value to the card balance, either initially or after some or all of the original balance is depleted through use, by calling a customer service telephone number and purchasing additional value with a standard credit card. Value may be added as well by a cash or check transaction at a retail point of sale, using the point-of-sale terminal and banking network to add value to the account balance. Value may be added as well through the use of an online interface.

The patient 102, wishing to receive healthcare services from a provider, presents his card 154 at the provider office 110 at the time of service. At the provider office is a computer 162 and a card reader 164, which is preferably attached to the computer 162. The computer is connected to at least one network, such as the Internet 124, enabling communication with outside parties, including the health plan organization 106. Additionally, the card reader 164 and/or the computer 162 are capable of connecting to a bank transaction network 168, through which various financial institutions transmit and receive credit card and other financial transactions. Through the use of the bank transaction network 168, the health/dental care provider 110 may receive payment for services rendered by having funds deposited into an account 170 held by a bank 172 or other institution. Additionally, in some embodiments of the invention, the patient 102 has an account 174 held by a bank 176 or other institution, which is similarly connected to the bank transaction network 168, and can be accessed to supplement any transaction for which there may otherwise be insufficient funds. The transfer of funds is preferably initiated or authorized by the health plan organization through a payment module of its system.

By receiving the patient's 102 card 154 at the provider office 110, the health care provider can use the computer 162 to communicate with the health plan organization 106 via the Internet 116 and obtain pertinent information, such as whether the patient 102 is eligible to receive health benefits under the terms of a health/dental insurance policy or other program. Additionally, in some embodiments of the invention, the provider 110 can receive from the health plan organization 106, through the network 116, notification of the applicable contracted prices for the services to be provided to the patient 102, through the use of a database system 167. In some embodiments, the provider 110 submits procedure codes and or diagnosis codes in order to obtain said applicable prices.

Upon provision of services, the provider 110 can swipe the card 154 via the card reader 164 and initiate a transaction for the services at the applicable prices. The transaction preferably takes the form of an ordinary credit card or debit card transaction, utilizing the bank transaction network 168 to facilitate transfer of funds. Upon successful processing of the transaction, the provider 110 receives a confirmation of the transaction or payment via the network 168. At this point, the provider 110 preferably sends information regarding the encounter (e.g., patient information, procedure code, diagnosis code, payment information, etc.) to the health plan organization 106, either electronically through a network such as the Internet 116 or in an off-line manner. The health plan organization 106 uses the information to match the encounter information to debit card transaction using its substantiation system 178 in order to substantiate that the services provided for the patient 102 were valid for coverage under the FSA, HRA or HSA 158 if necessary. In some embodiments, the substantiation procedure performed by the health plan organization 106 is performed automatically using electronic information submitted by the provider 110. In some embodiments, the substantiation process is performed in an online manner at the time services are provided to the patient 102. In other embodiments, no substantiation is necessary.

Additionally, in some embodiments of the invention, back-end verification may be performed to ensure that any applicable contracted price was in fact applied for the transaction. Such verification may be performed, for example, on an aggregate level in order to compare a sum of those contracted prices provided to service providers to a corresponding sum of those prices actually charged to pre-funded accounts. This provides an additional level of protection to consumers. A verification system 180 located at the health plan organization 106 or elsewhere may perform these functions.

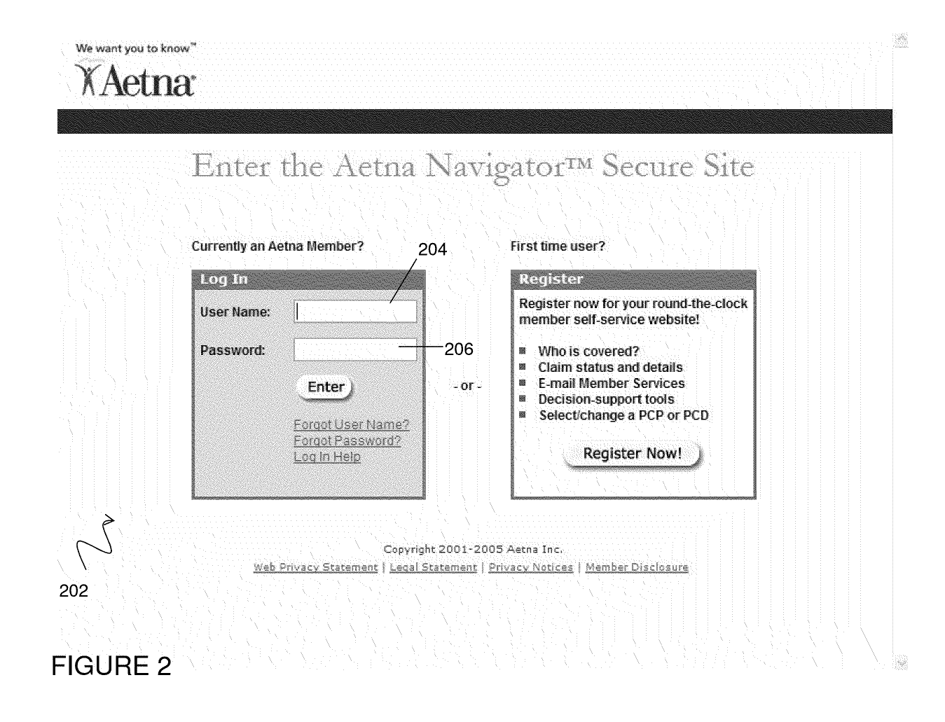

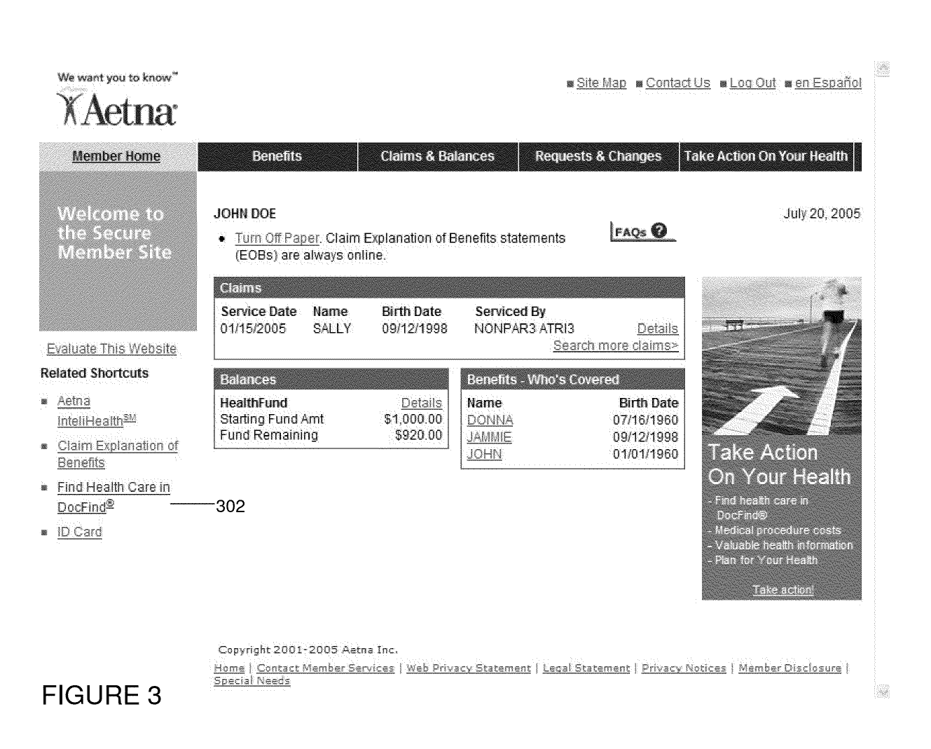

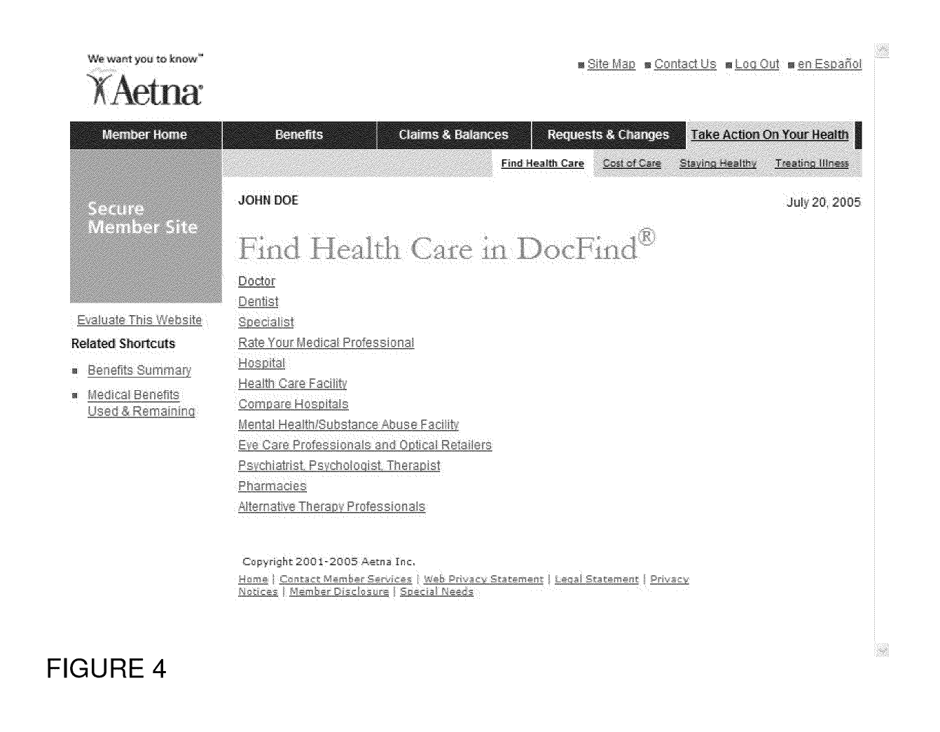

FIGS. 2-8 illustrate a sample interface provided by an HPO for presenting health care provider information, as used in an embodiment of the invention. In FIG. 2, a login screen 202 is shown whereby a member can enter a username 204 and password 206 in order to obtain access to the system. Alternatively, or in addition, non-members can access the system under particular circumstances. In FIG. 3, basic member information is presented as obtained, for example, from member and/or claims databases. Also presented in the screen of FIG. 3 is an option to find health/dental care providers 302. By selecting this option, a member is presented with another screen as shown in FIG. 4, where the member can choose the type of health/dental service provider or facility for which he would like more information.

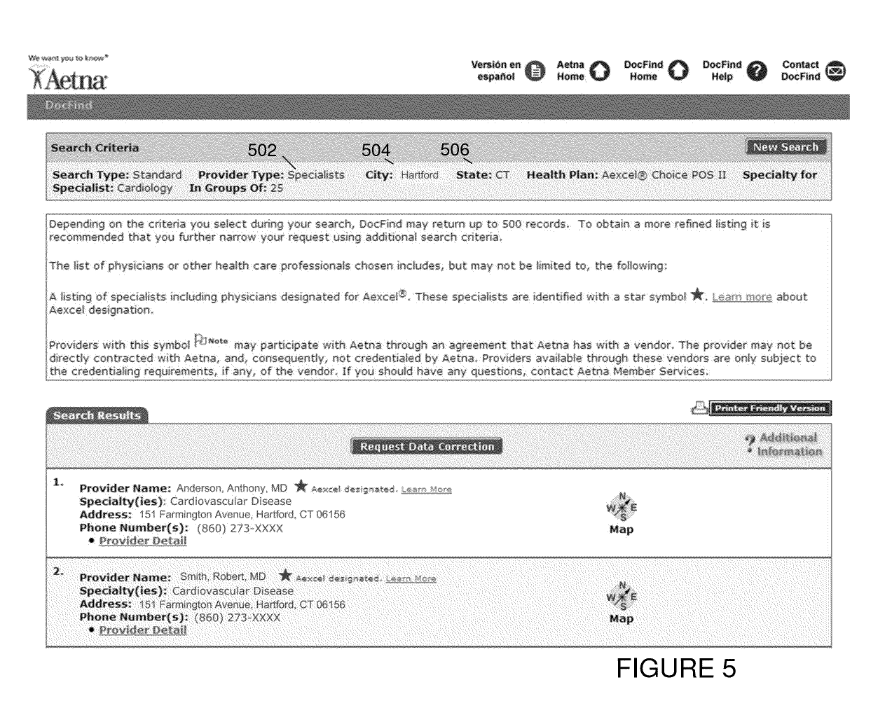

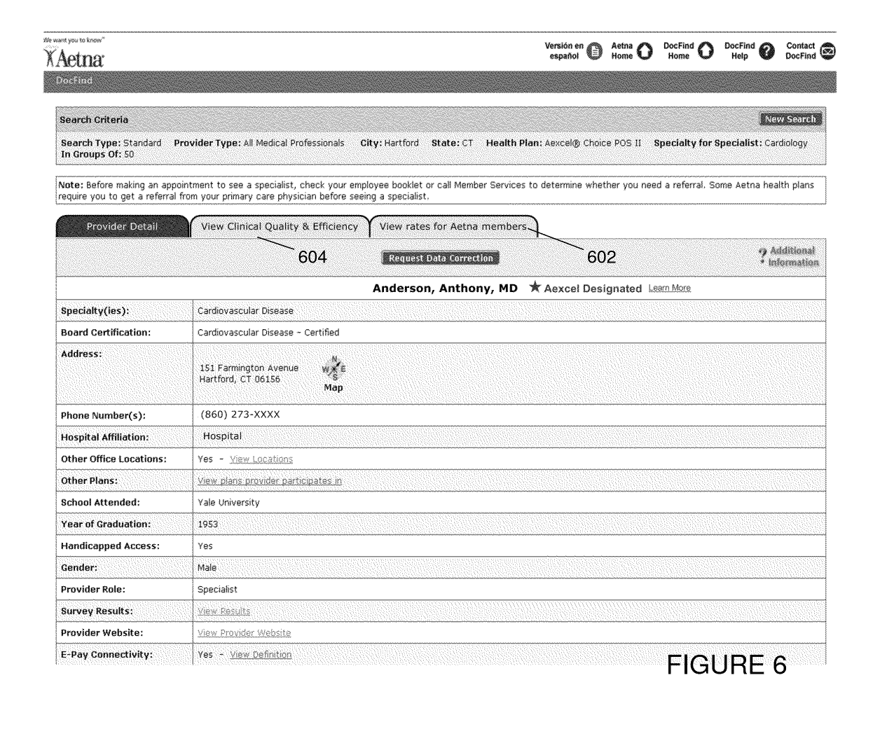

FIG. 5 illustrates the results of a query where the member has requested information on “Specialists” 502 within a city 504 and state 506. Other search criteria, (e.g., providers within a twenty mile radius of a specified zip code) are also available. Basic information (e.g., name, specialty, address and phone numbers) for contracted health services providers matching the query criteria are presented in response to the query. Additionally, an option 508 is presented for obtaining additional details on particular providers. These additional details are provided in a screen such as the one shown in FIG. 6, and preferably include details such as the provider's education, hospital affiliations, gender, or other information that may be of value to consumers. An option 602 is further presented to view the provider's contracted rates for provision of services to HPO members. An option 604 is presented to view the provider's quality and efficiency information.

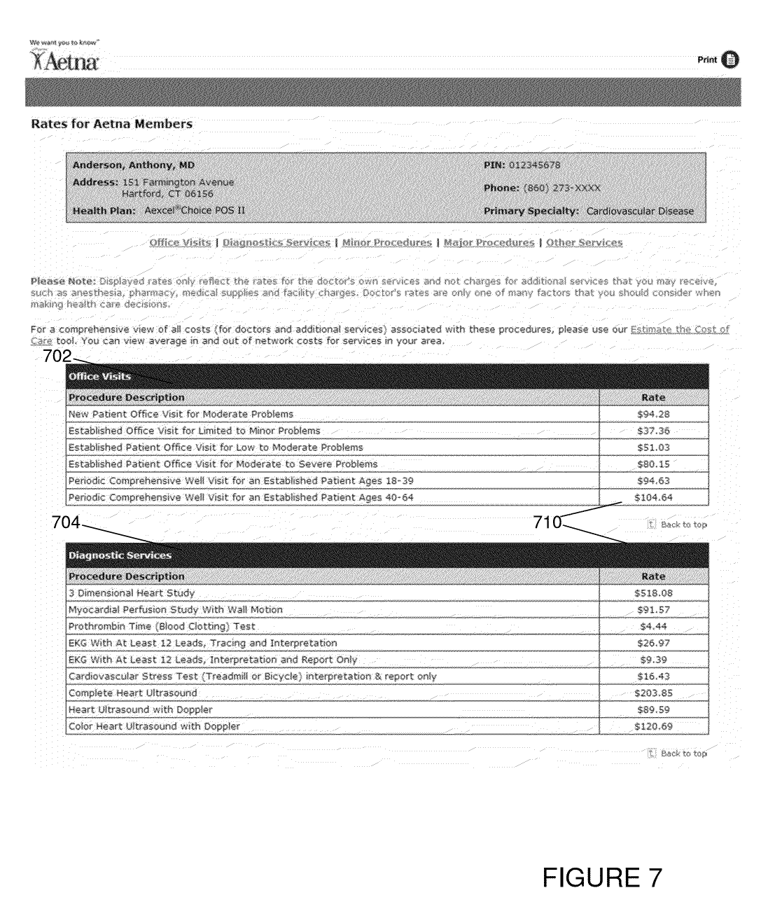

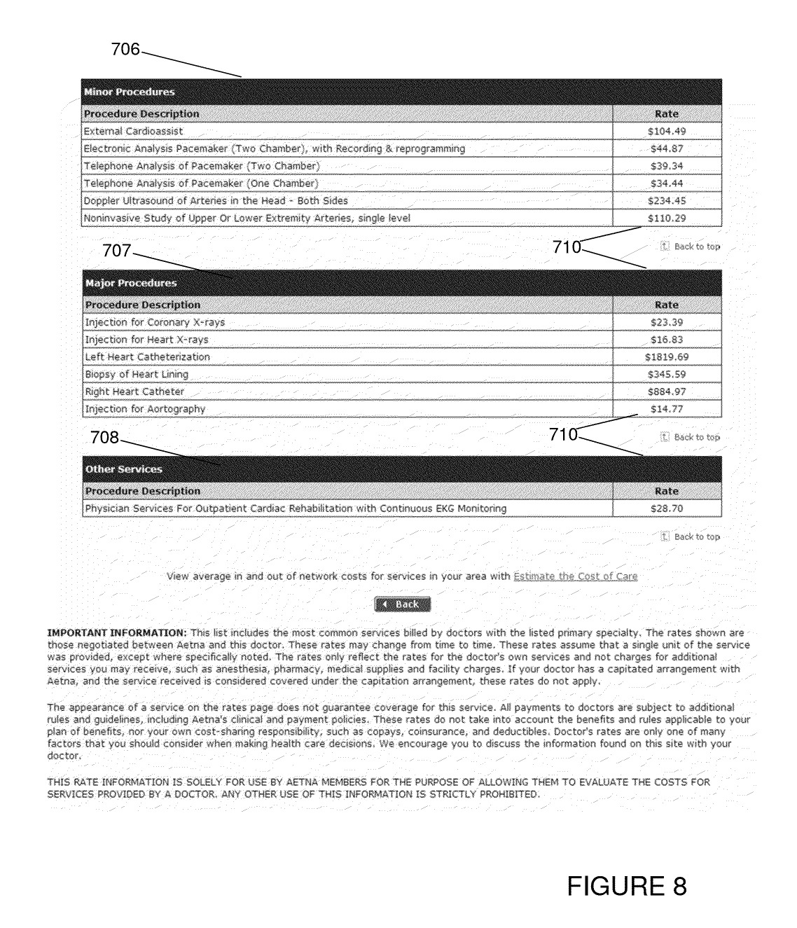

When the option 602 is selected, the member is preferably presented with one or more screens such as those shown in FIGS. 7-8. The screens contain one or more tables 702, 704, 706, 708. Each table contains a group of categorized procedures, such as Office Visits 702, Diagnostic Services 704, Minor Procedures 706, Major Procedures 707 (births, Caesarean sections, shoulder surgery, multiple bypass surgery, radiology procedures, etc.), or Other Services 708. The procedures displayed are preferably unique to the given specialty of the provider, so that the procedures displayed for a cardiologist will differ from the procedures displayed for a pediatrician, for example. For each procedure in a table, a rate 710 is shown. The rate 710 represents the amount that the provider will be reimbursed for performing the corresponding procedure. Depending on the member's health plan, he may pay less for these services if any portion is to be paid by the HPO. The invention is not limited to the interface as shown in FIGS. 7 and 8, however. In some embodiments of the invention, the actual amount to be paid by the member is presented. In some embodiments, only a selection of possible procedures are presented via the interface (e.g, the 30 most frequently performed). The determination of which procedures are to be presented can be made by a preferably quantitative procedure, such as examining which procedure codes (CPT) appear most frequently on previously submitted claims for the specialty.

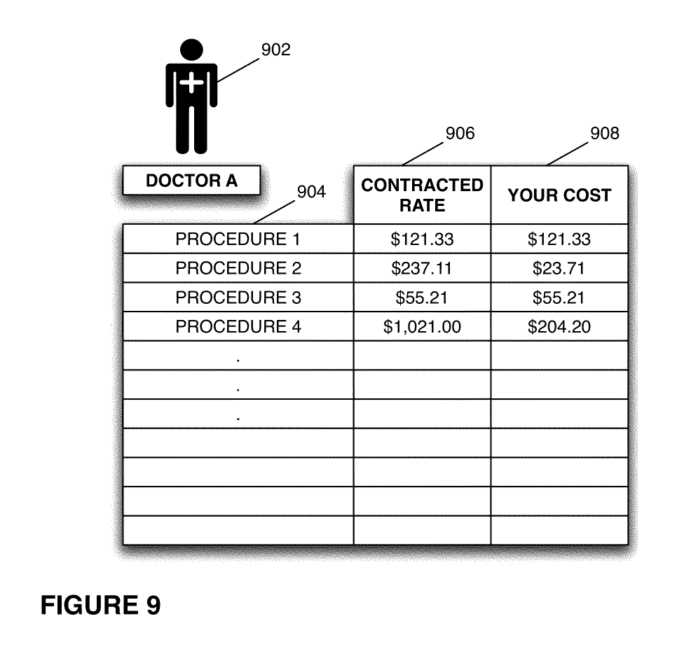

Turning to FIG. 9, an exemplary screen is shown whereby a member can obtain cost information for a contracted health services provider 902, in accordance with an embodiment of the invention. As in FIGS. 7 and 8, a variety of health service procedures performable by the provider 902 are listed in one column 904. The listed procedures in the column 904 are preferably presented in a nomenclature easily understandable to a layman, which may differ from an actual formal description associated with a procedure's CPT code. A second column 906 contains the negotiated contracted rate the provider will be reimbursed for performing the procedure. A third column 908 contains the actual cost the member would pay for having the service performed by this provider. This actual cost can differ from the contracted rate due to terms of the member's health plan, which can be stored in one of the HPO's databases. Differences may result from coinsurance, co-payments, satisfaction of deductibles, etc.

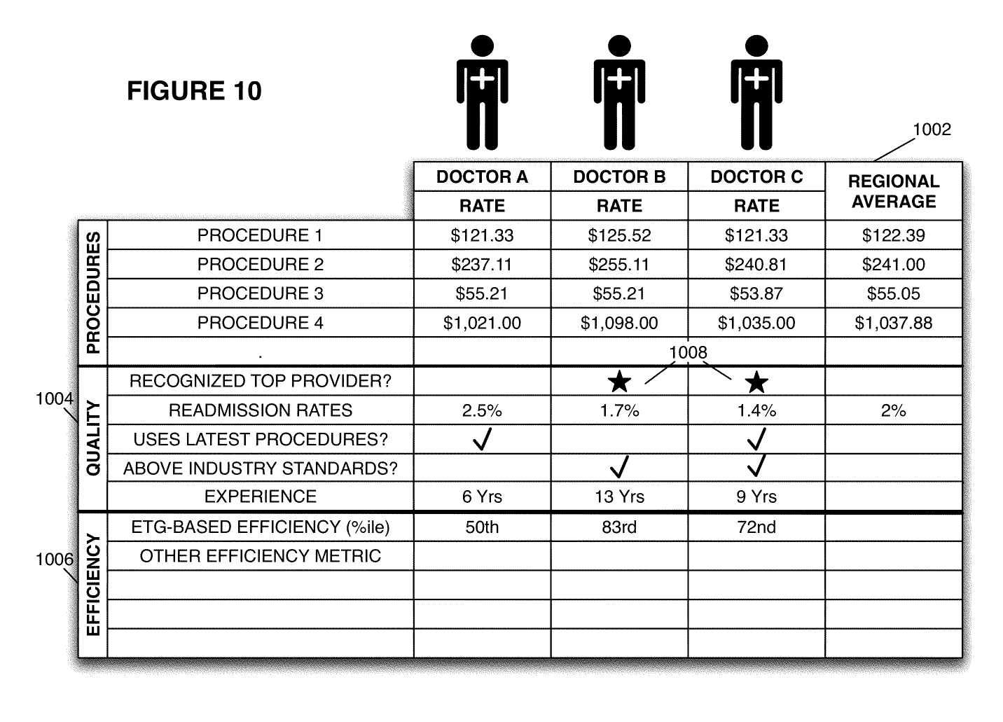

In some embodiments of the invention, comparative information is provided for multiple health service providers, as illustrated in FIG. 10. In addition to the columns previously described with respect to FIGS. 8 and 9, multiple columns are presented for multiple health service providers to allow for side-by-side comparison with respect to given procedures. For example, the contracted rate for a procedure to be performed by Doctor A may be less than the contracted rate for the same procedure when performed by Doctor B. Such a direct comparison and revelation of contracted rates has not been available in previous systems. In some embodiments of the invention, the comparative information in the table is sortable by selected criteria, which is particularly useful if a number of providers are being simultaneously compared.

In addition, a column 1002 is shown to provide a regional average contracted rate for a given procedure, as used in some embodiments of the invention. The regional average can be calculated for the member based on a location specified in a query, or based on his customer information stored in an HPO database. In some embodiments, the size of the region can be customized on a query-by-query basis (e.g., “within 10 miles”), or based on zip code, or other geographic identifier.

Also shown in FIG. 10 are additional evaluation criteria that may be useful to consumers making health care decisions. Such criteria include quality metrics 1004 and efficiency metrics 1006. The quality metrics 1004 can include, for example, whether a health services provider has been recognized as an outstanding provider. Doctors B and C in FIG. 10 are shown in the example to be outstanding providers by the stars 1008 in their respective table cells. The recognition can come from the HPO based on internal or external metrics, or from outside parties such as certifying agencies like AQA (Ambulatory Care Quality Alliance) or The Leapfrog Group.

Another of the quality metrics 1004 is the rate of readmission of a provider's patients for similar treatments. A lower readmission rate may indicate to a prospective patient that one provider provides a higher quality of care than another. A period of time may be used (e.g., 30 days) to determine if patients have been readmitted. Similarly, information regarding the number or frequency of adverse effects in patients of the provider can be used as a quality metric. Another of the quality metrics 1004 is whether a provider uses the latest health care procedures, or performs according to or in excess of industry standards. For example, one metric can be whether an Ob/Gyn screens for cervical cancer, or performs HIV tests, during routine examinations. Data for such metrics can be obtained, for example, from past claim data submitted with respect to the particular provider. Additionally, other metrics can be used as proxies for quality, such as the number of years of experience a provider has, the volume of the number of patients using the provider, or the volume of the services performed by the provider. In some embodiments of the invention, survey data is included as a quality metric, such as from a patient satisfaction survey or an industry peer survey.

Efficiency metrics 1006 can also be used and presented to the member. Efficiency can measure, for instance, the total cost for treatment of a particular medical condition. Because the treatment may comprise multiple procedures and other expenses (pharmaceutical, lab, hospitalization, etc.), such an efficiency metric for a given provider can be of greater value to a prospective patient than the costs of individual procedures, since the sum total of all expected health care costs for that patient may be less with one provider who is more efficient than another. Efficiency metrics can be evaluated using past claim data submitted with respect to providers. Claim data generally contains “procedure codes” and “diagnosis codes”. Claims can thus be grouped into episodes of treatment, or ETGs (“episode treatment groups”), which can further be associated into particular health conditions. By aggregating the costs of claims within ETGs or conditions, efficiency metrics can be computed and compared across providers.

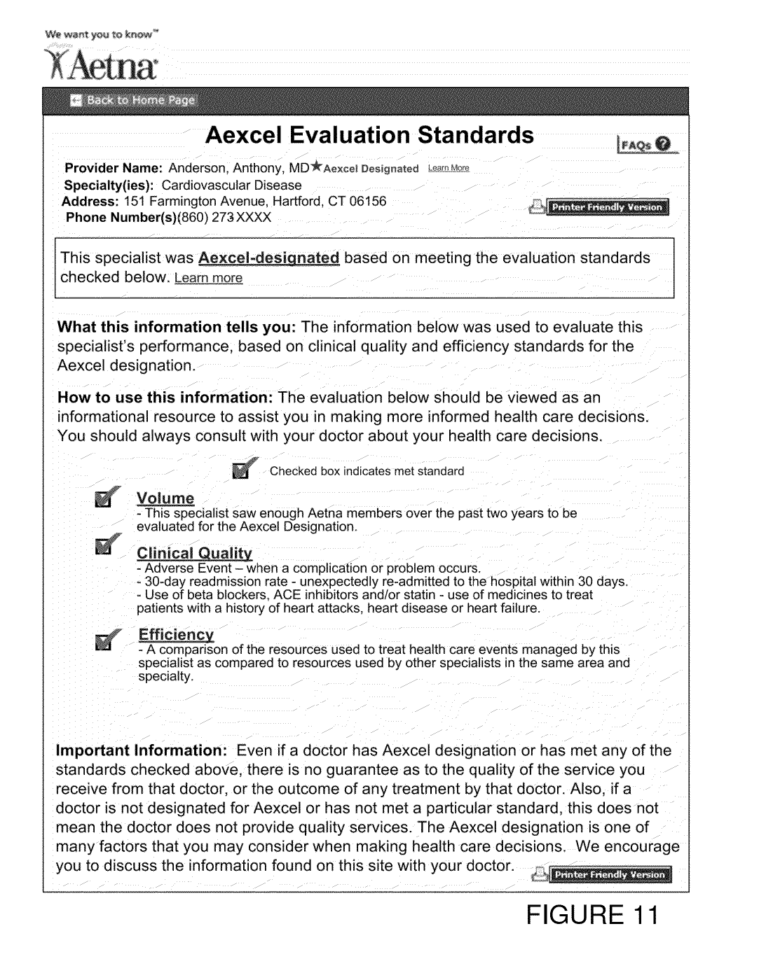

An additional example of a presentation of quality and efficiency information to prospective consumers of a health care provider is shown in FIG. 11.

In some embodiments of the invention, cost information is provided not only for individual procedures, but for all anticipated costs associated with a procedure. For example, a prospective patient investigating the cost of having an outpatient surgery is presented not only with the contracted rate from the physician, but with contracted rates for the hospital or clinic where the surgery is to be performed, an anesthesiologist who may be required, associated laboratory fees for required testing, and the like. In some embodiments, expected pharmaceutical costs are also included. Such a “soup-to-nuts” pricing estimate may be of tremendous value to prospective patients of elective or planned surgeries, and can make use of existing evaluation tools that may exist or be developed for individual components (e.g., tools for comparing hospital costs). Additionally, in some embodiments of the invention, prospective patients are presented with contracted rates for a health service to be provided at one or more particular sites of service. In this way, a prospective patient can compare the cost of having a procedure performed at one site (e.g., a hospital) versus another site (e.g., an outpatient clinic).

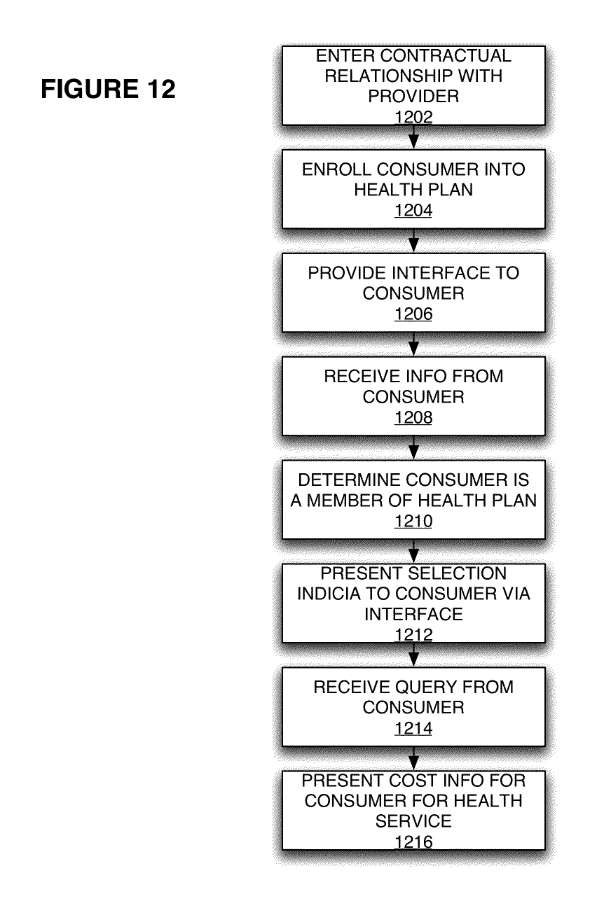

Turning to FIG. 12, a method is shown for providing cost information to a prospective consumer of health/dental services, in accordance with an embodiment of the invention. A health plan organization (HPO) enters a contractual relationship with a health services provider at step 1202. The contract sets a schedule of rates for which the provider is reimbursed for providing services to patients who are members of the HPO. The HPO enrolls a consumer as a member of one of its offered health plans at step 1204 and provides him an interface at step 1206. At step 1208, the HPO receives information from the consumer (e.g., a username and password) and determines that the consumer is a member of a health plan offered by the HPO at step 1210. The consumer is presented, through the interface, with a selection options for querying about provider and/or procedure data at step 1212. The query is received at step 1214 and, in response, cost information is presented to the consumer at step 1216.

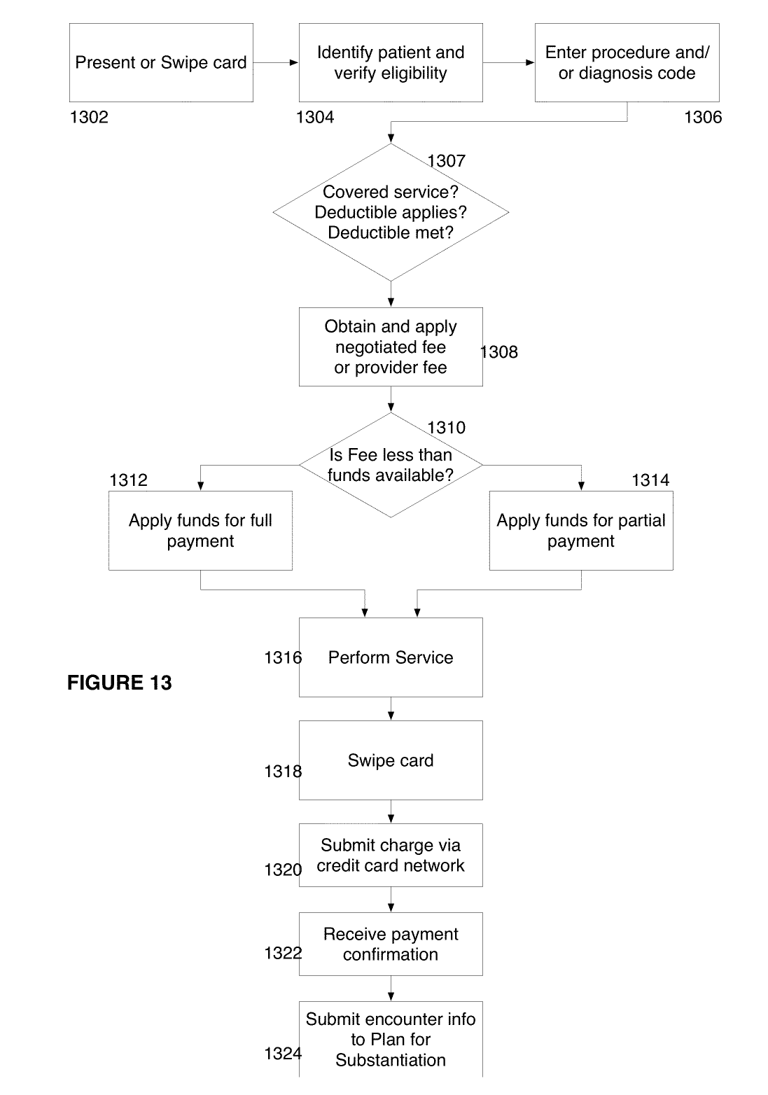

Turning to FIG. 13, a flowchart illustrates a method of using a health/dental care card at a health service provider to allow real-time payment to the provider at a contracted rate. The card is presented or swiped at step 1302 in order to enter patient and billing information into a computer. The computer, connected to the health plan organization via a network such as the Internet, submits the patient information to check his eligibility for coverage at step 1304. If necessary, the health plan organization requests the provider to provide additional patient information. The provider uses the computer to enter information regarding the services to be provided, such as a procedure code and diagnosis code, at step 1306, and submits this information to the health plan organization. In some embodiments, a diagnosis code is only entered for those services for which there is some possibility of a non-allowed status (e.g., a potentially cosmetic procedure). Alternatively, the diagnostic code is required for all charges to provide a more complete member data record. In response to the data entry, it is determined at step 1307 whether or not the service is covered under a contracted fee schedule, and whether or not funds must be paid by the patient from a deductible. If the service is covered, then at step 1308 the provider receives the applicable fee to charge the patient for the service, in accordance with a previously negotiated agreement between the provider and the health plan organization. In some embodiments of the invention, the fee schedule for a particular provider can depend on the location where the services are provided (e.g., in the provider's office or in a hospital), so information regarding the site of service is preferably submitted in addition to or accompanying other information. If the service is not covered, the provider may charge the patient an appropriate fee. If the service is subject to a deductible, the applicable fee is preferably reduced by the extent to which the patient's deductible has already been met. The contracted fee is preferably the same regardless of whether or not the patient has coverage under a health/dental insurance policy. Using the billing information provided by the card, the computer inquires at step 1310 whether there are sufficient funds available in the patient's linked account to cover the applicable fee. If so, a transaction is set up to fully fund the fee from the linked account at step 1312. If not, a transaction is set up at step 1314 to partially fund the fee from the linked account, with the remainder to be paid via other means. After the health/dental services are performed at step 1316, in some embodiments of the invention the card is swiped again at step 1318 to initiate a charge against the linked account. The charge is submitted at step 1320 and the provider receives confirmation of payment at step 1322. At this point, information regarding the encounter is sent either via the computer or through conventional means to the health plan organization at step 1324, in order that it can be substantiated as valid under the FSA/HRA/HSA guidelines if necessary.

In some embodiments of the invention, the substantiation process is performed automatically, in real-time and prior to the submission of any charge for the health/dental services performed. The ultimate level of auto-substantiation in embodiments of the invention is comparable to that of a manual process, relying on diagnosis of an illness or injury or, in the absence of an applicable diagnosis, certification as to the purpose of the treatment from the provider. The system preferably substantiates every encounter submitted, rather than using any statistical sampling. However, in some embodiments, no substantiation is performed at all.

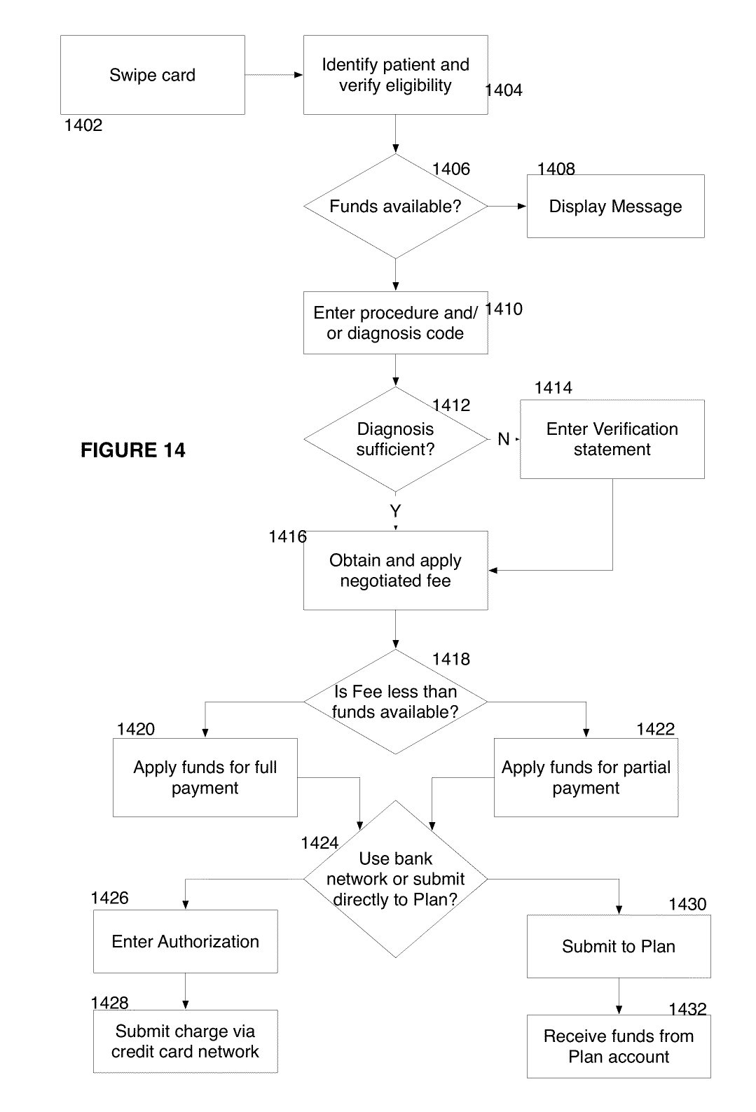

An illustration of an embodiment in described with respect to FIG. 14. A patient's health/dental care card is presented or swiped at step 1402 in order to enter patient and billing information into a computer. The computer, connected to the health plan organization via a network such as the Internet, submits the patient information to check his eligibility for coverage at step 1404. If necessary, the health plan organization requests the provider to provide additional patient information. As an initial validation step, the computer inquires whether any funds are available in the linked FSA/HRA/HSA or other type of pre-funded account at step 1406. If not, a message is preferably returned at step 1408. Otherwise, the provider uses the computer to enter information regarding the services to be provided, such as a procedure code and diagnosis code, at step 1410, and submits this information to the health plan organization. If necessary, the health plan organization substantiates the information at step 1412 according to FSA/HRA/HSA guidelines to see if the diagnosis/procedure submitted for this patient is sufficient. In one embodiment, the information is substantiated by comparing one or both of the diagnosis and procedure code to a database of activities known to fall outside the FSA/HRA/HSA guidelines (e.g., purely cosmetic procedures). If the submitted information is insufficient, the provider is prompted via the computer to enter a verification statement at step 1414 to certify that, for example, the health service is being provided to treat or prevent disease and is not for cosmetic or convenience purpose. At step 1416, the provider receives the applicable fee to charge the patient for the service, in accordance with a previously negotiated agreement between the provider and the health plan organization. This contracted fee is preferably the same regardless of whether or not the patient has coverage under a health/dental insurance policy or other program. Using the billing information provided by the card, the computer inquires at step 1418 whether there are sufficient funds available in the patient's linked FSA/HRA/HSA or other type of pre-funded account to cover the applicable fee. If so, a transaction is set up to fully fund the fee from the linked account at step 1420. If not, a transaction is set up at step 1422 to partially fund the fee from the linked account, with the remainder to be paid via other means.

In some embodiments of the invention, the provider has an option at step 1424 to either submit the charge via a debit/credit card network or directly to the health plan organization (via, for example, the Internet). If a debit/credit card network is to be used, then the provider is given an authorization code from the health plan organization at step 326. The authorization code verifies that the charge has been substantiated and allows the charge to be linked to the plan's substantiation file. The charge is submitted at step 1428 and funds are held against the FSA/HRA/HSA or other type of pre-funded account to assure payment of the charge. If the provider submits the charge directly to the health plan organization at step 1430, then the health plan organization causes payment to be made directly to the bank account of the provider's office, which receives the funds at step 1432. The provider in this way receives immediate or near-immediate payment for the services rendered.

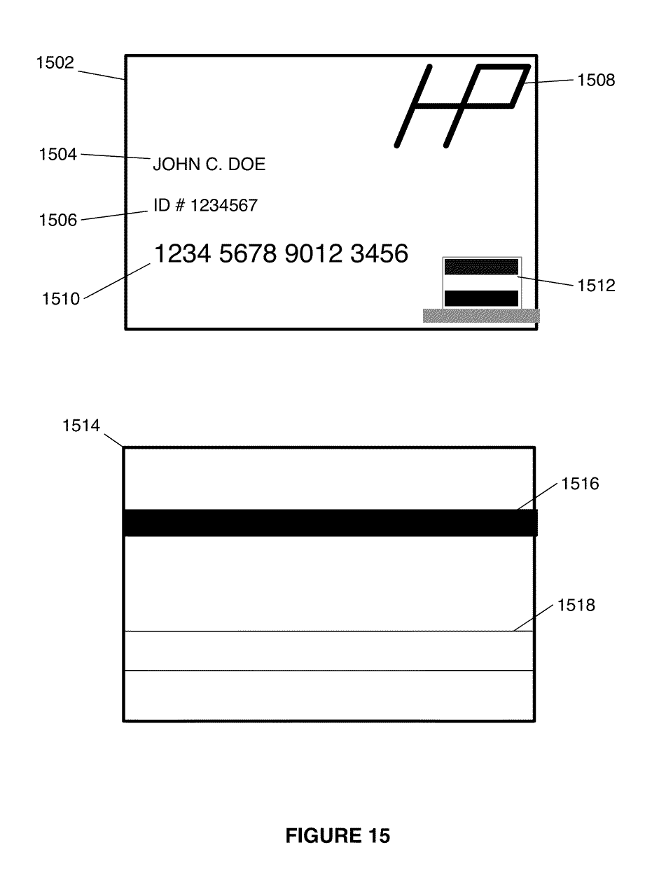

Turning to FIG. 15, and exemplary health/dental care card with credit/debit feature is shown, in accordance with an embodiment of the invention. The card is linked to an FSA, HRA or HSA account, or other type of pre-funded account, corresponding to the cardholder, or maintains a stored value, and is issued by a health plan provider. On the face 1502 of the card, information is printed regarding the identity of the cardholder, including the cardholder's name 1504 and identification number 1506. The face 1502 of the card also contains a logo 1508 or name of the health plan provider, a sixteen-digit account number 1510 for use in credit/debit card transactions, and the name or logo 1512 of the network on which the credit/debit transactions should be processed (e.g., MasterCard, Visa, Discover, etc.) On the back of the card 1514 is a magnetic strip 1516 containing account and/or patient indicia suitable for reading with a magnetic card reader. The card 1514 may also contain a signature field 1518 on the back of the card 1514 on which the cardholder may sign. Additionally or alternatively, the card can be equipped with a RFID chip or similar device to allow for reading and/or writing information from/to the card based on proximity of the card to a read/write device.

In addition to FSAs, HRAs and HSAs, a health/dental care card such as the one described above is used to link to additional types of accounts in some embodiments of the invention. For example, a card can link to an employee's account that is funded through payroll deductions (post-tax) by his employer. Such an arrangement can allow employees to budget their health/dental care dollars on a monthly basis, and allows access to preferential contracted rates of service providers. Either the employee or employer can pay any monthly fee charged by the card administrator. Alternatively, a card can link to a “virtual” or notional account that may not contain actual funds, but instead represents, for example, an unsecured commitment by an employer to pay for applicable health/dental care services charged to an employee's health/dental care card. Alternatively, a card can link to an account established and funded directly by a consumer, not through his employer.

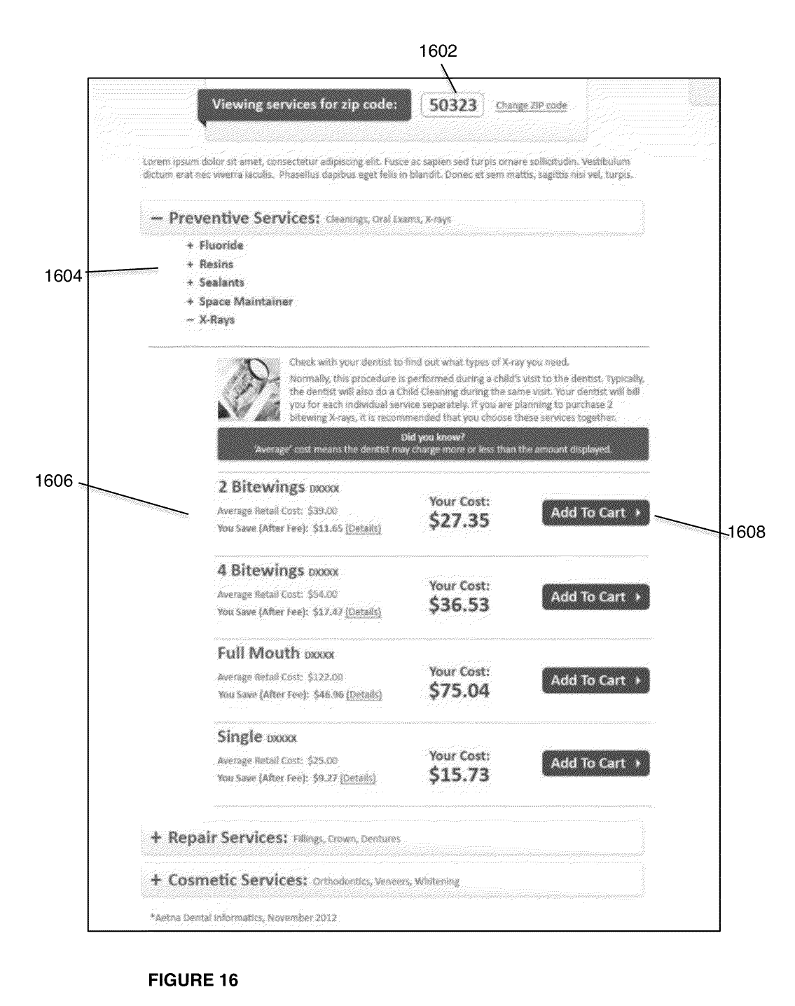

Turning to FIG. 16, a sample webpage from a portal for purchasing/loading a card for use in the dental care context is shown. A consumer accessing the portal may query the rates for various dental services. A zip code field 1602 permits searching rates based on geographic location. Additional refinement of searching may be based on categories of dental services (e.g., Preventive Care, Repair & Restore, Cosmetic, etc.), or particular types of services 1604 within a category (e.g., Abscessed tooth, bite adjustment, bridges, crowns, dentures, emergency care, etc.). For a selected type of service, the portal preferably provides price comparison information 1606, including, for example, the average retail cost for the service within the geographic area (i.e., non-contracted rate), the average network cost (i.e., contracted rate), and the resulting savings by using the card. Further transparency to the customer is provided with the identification of a processing and access fee, which may be added to the purchase. The savings is calculated after any fee is applied.

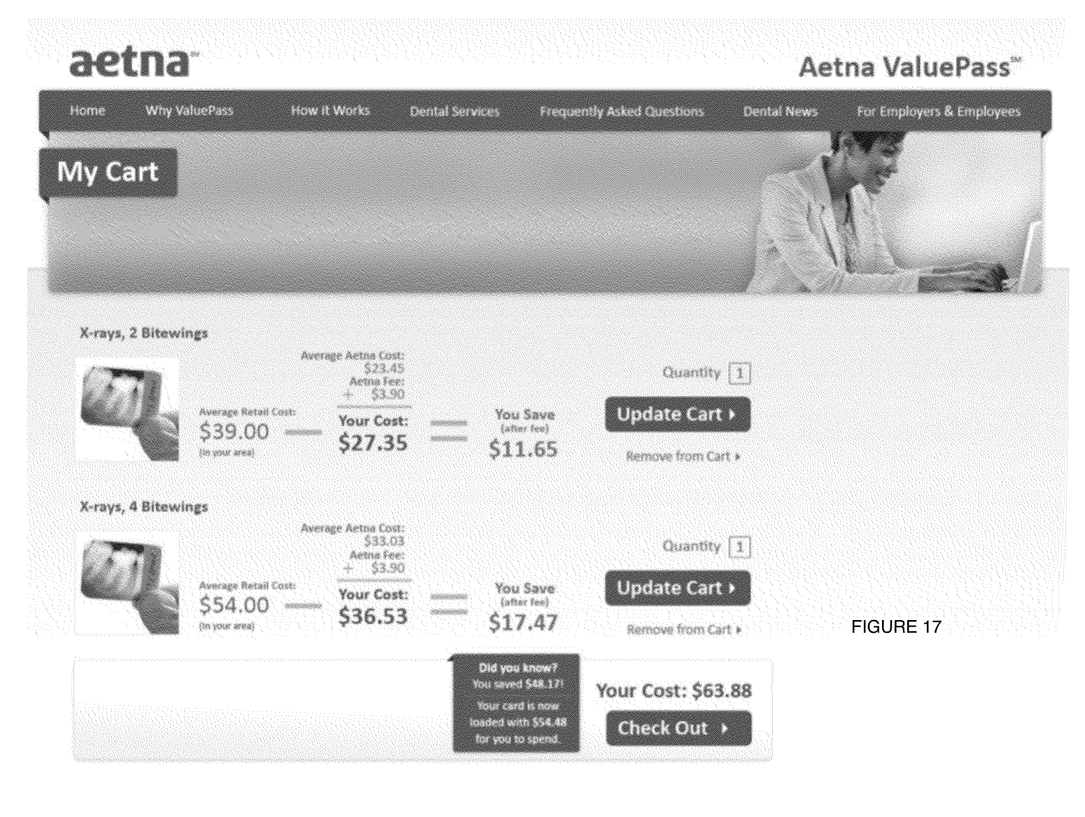

The savings may equal the difference between the average retail and average network costs, and/or may include additional processing or management fees. An option 1608 is preferably provided for the consumer to add the dental service to a virtual shopping cart. A sample virtual shopping cart is shown in FIG. 17, listing the names of the selected services and the corresponding cost information. The consumer is preferably given the choice of purchasing either a card or a printable certificate for the contracted value of the selected services.

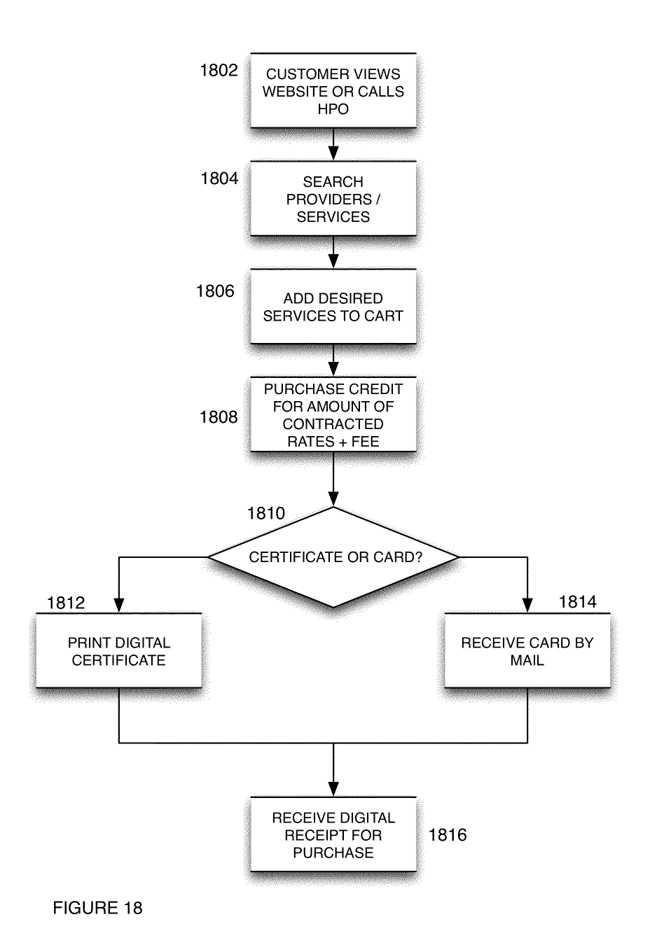

FIG. 18 is a flow diagram representing a customer's purchase of a health/dental care card or certificate, in accordance with one embodiment. The customer accesses a website or telephone center for HPO's program at step 1802. The customer can then search for particular health/dental services for potential purchase at step 1804. This may entail the use of a geographic filter, such as entry of a zipcode for the area in which the services are to be provided. The customer is presented with cost information for particular services in the desired area, such as the average retail cost for the service (i.e., what is typically charged to patients without insurance), and the average contracted rate (i.e., a maximum amount that the providers have agreed with the HPO to charge to insured patients for the services). At step 1806 the customer adds the desired services to his virtual shopping cart maintained on the website, and proceeds to purchase a credit for these services at step 1808. The amount of the credit purchased is equal to the amount of the contracted rates for the desired services, plus any applicable fees. The customer uses a credit card, debit card, PayPal, or other transactional method to pay for the credit. The customer also decides at step 1810 whether to receive the credit in the form of a certificate or a card. If a certificate is chosen, then the customer is provided instructions for printing the certificate, or it is made available for electronic presentment by the customer to the provider (e.g., via a smart phone application) at step 1812. If a card is chosen, then the customer receives the card by mail or carrier at step 1814. In the event a customer already has a card, the value of the purchased credit is added to the existing card, and no additional card need be mailed. The customer also receives an electronic receipt for his purchase at step 1816, preferably indicating the chosen services and the amount paid for the credit.

In accordance with an embodiment, the purchase of health/dental cards can be managed fully or partially by an employer. For example, the employer may be permitted to load value onto the existing cards of its employees. Alternatively or additionally, the employer may promote the use of the health/dental cards by providing a link on its corporate website to the HPO's card management site. In accordance with another embodiment, an employer takes a more active role, and creates cards or certificates for its employees as needed, using funds set aside by the employer. For example, the employer can coordinate a traveling employee's visit to a remote dentist, creating a certificate and contacting the dentist so the employee merely needs to show up for an appointment.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for providing a dental care consumer with information for a prospectively performed dental service, the method comprising:
entering a contractual relationship with a dental care provider to compensate the provider in a predetermined monetary amount for performing a dental service for members of a dental plan;
providing a computer interface to the consumer, the consumer not a member of the dental plan;
receiving from the consumer, via the computer interface, a request for cost information for the prospectively performed dental service;
presenting, for the consumer, cost information for the prospectively performed dental service, the cost information comprising the predetermined monetary amount and in accordance with the dental plan;
presenting an offer to the consumer to purchase a financial alternative to currency for the predetermined monetary amount, the financial alternative to currency for the consumer's use in satisfaction of payment to the dental care provider for performing the dental service.

2. The method of claim 1 wherein the financial alternative to currency is a prepaid debit card.

3. The method of claim 1 wherein the financial alternative to currency is a printable digital certificate.

4. The method of claim 1 wherein the financial alternative to currency is associated with a dental care account for the consumer, and wherein the account is maintained by the consumer's employer.

5. The method of claim 1 wherein presenting cost information further comprises presenting cost information limited to a geographic region.

6. The method of claim 5 wherein presenting cost information comprises computing an average cost for the prospectively performed dental service across dental providers in the geographic region.

7. The method of claim 2 wherein presenting the offer to the consumer further comprises presenting an offer to add an amount of funds to an existing prepaid debit card already possessed by the consumer, the amount equal to the predetermined monetary amount.

8. A system for payment of expenses for dental care services provided to a patient by a dental service provider, the system comprising:
a dental care card provided to the patient and containing information corresponding to a dental care expense account associated with the patient;
a database system associated with a health plan organization and storing contracted fee schedules, the health plan organization being associated with the card and the account; and
a computing device for presenting an interface to the patient, the interface comprising:
a first portion for presenting information regarding contracted fees for the dental care services; and
a second portion for presenting an option to add an appropriate amount of funds, corresponding to the contracted fees for the dental care services, to the patient's dental care expense account.

9. The system of claim 8 wherein the dental care expense account is maintained by the patient's employer.

10. The system of claim 8, the interface further comprising a search portion for specifying a geographic region.

11. The system of claim 10, the first portion of the interface further for presenting contracted fees for the dental services within a specified geographic region.

12. The system of claim 11, the first portion of the interface further for presenting average cost information for the dental service across dental providers within the geographic region.

13. The system of claim 9, further comprising a financial transaction network for transferring funds from an employer account to the account dental care expense account.

14. A method for a consumer to obtain preferred rates for the provision of prospectively performed dental services, the preferred rates being contractually fixed between a dental care provider and a health plan organization, the method comprising:
searching, via a computer interface for the health plan organization, for information related to the dental services;
obtaining, via the computer interface, cost information regarding the contractually fixed rates for the dental services;
purchasing, via the computer interface, a credit to be applied to a dental care account corresponding to the consumer and to the health plan organization, the amount of credit equal to the sum of the contractually fixed rates for the dental services;
receiving a financial alternative to currency linked to the dental care account; and
presenting the financial alternative to currency to the dental care provider at the time dental services are to be performed, in satisfaction of payment for performance of the dental care services.

15. The method of claim 14 wherein the financial alternative to currency is a prepaid debit card.

16. The method of claim 14 wherein the financial alternative to currency is a printable digital certificate.

17. The method of claim 14 wherein the dental care account is maintained by the consumer's employer.

18. The method of claim 14 wherein searching comprises specifying a geographic region, and wherein the obtained cost information is specific to the geographic region.

19. The method of claim 18 wherein the obtained cost information comprises an average cost for the prospectively performed dental service across dental providers in the geographic region.

20. The method of claim 15 wherein an amount of funds are added to an existing prepaid debit card already possessed by the consumer, the amount equal to the amount of credit purchased.
